(19) United States
(12) Patent Application Publication
(10) Pub. No.: US 2004/0089814 A1
(43) Pub. Date: May 13, 2004

(54) Image capture system and method

(75) Inventor: Stephen Philip Cheatle, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/697,874

(22) Filed: Oct. 31, 2003

(30) Foreign Application Priority Data
Oct. 31, 2002 (GB) 0225406.8

(51) Int. Cl. G01K 1/08; H01J 3/14; H01J 3/26

(52) U.S. Cl. 250/397

(57) ABSTRACT

Motion signals from head and body motion detectors are combined to measure motion of a user's head with respect to his body. A field of view of an image capture device is moved based on the measured motion of the user's head with respect to his body.

### FIELD OF THE INVENTION

The present invention relates to an image capture system and method.

### BACKGROUND ART

A head mounted image capture device, e.g. a camera, has the advantage that image capture device points in the same direction as the wearer, i.e. user, is facing. Consequently, the camera “sees” roughly what the wearer is looking at. However, a significant disadvantage of head mounted cameras is that the camera has to be pointing in the same direction as the face and as a consequence is generally visible. Potential wearers of cameras tend to be concerned about their facial appearance and are reluctant to have large devices attached to their heads. Attempts have been made to miniaturise wearable cameras and disguise them in glasses or hats. These approaches are only partially successful and tend to result in serious compromises in image quality.

A further problem relates to the electronics associated with the camera. All wearable cameras require some additional devices, e.g. a power supply, an image processor, a storage device or data transmitter. Typically, these additional devices are not located on the wearer's head and are typically coupled to the image sensor by a cable. The cable connection makes head mounted cameras inconvenient to put on and take off. It is also unsightly, requiring the wearer to go to some trouble to conceal it. Proposals for a wireless connection between a camera head and the associated electronics generally impose severe bandwidth restrictions, which make high quality still or video capture very difficult.

Attempting to conceal a head mounted camera in order to prevent the camera from detracting from the wearer's appearance is easily misconstrued as an attempt to take covert pictures. This has negative social implications which overt cameras do not suffer from.

It is an object of the present invention to address the above mentioned disadvantages.

### SUMMARY OF THE INVENTION

One aspect of the invention relates to an image capture system comprising a body-mountable image capture device, a detector arrangement for detecting the relative motion of the head and body of a person on whom the image capture device is adapted to be mounted, and a combiner adapted to be coupled with the image capture device and the detector arrangement. The combination is arranged for moving a field of view adapted to be captured by the image capture device based on the detected relative motion of the head and body of the person.

Preferably, the detector arrangement includes separate motion detectors for the head and body of the person that are adapted to be mounted on the person.

The body mountable image capture device is preferably a camera adapted to be secured to the body of the user.

The combiner is preferably included in a computing device.

The combiner preferably includes an image capture device adjustment section and is preferably operable to control the adjustment section to move a field of view of the image capture device.

The combiner is preferably adapted to respond to the detector arrangement and to derive an indication of rotation of the head of the user relative to the body of the user. In one embodiment, the image capture device adjustment section is operable to move the field of view of the image capture device by an amount corresponding to the indication of head rotation relative to the body of the user. In a second embodiment, the image capture device adjustment section is operable to move the field of view of the image capture device by an amount greater than the measured relative head to body motion.

The head motion detector is preferably secured to the head of the user to detect lateral rotation of the head of the user.

The body motion detector is preferably included in, or is a part of, the image capture device.

In a preferred embodiment, the image capture system also includes a distance sensor operable in conjunction with a known distance between the eyes of the user and the image capture device, to compensate for parallax errors associated with the eyes of the user.

The image capture system also preferably includes a calibrator operable to calibrate a forward direction for the motion detector arrangement in response to an indication of an average output of the motion detector arrangement adjusted so there is substantially no offset between facing directions of the body and head of the user.

The image capture device preferably includes a tilt detector operable to adjust an image of the image capture device to account for titling of the image capture device away from the horizontal.

Another aspect of the invention relates to a method of controlling an image capture device secured to the body of a user. The method comprises moving a field of view of the image capture device according to detected motion of the head of the user with respect to detected motion of the body of the user.

Preferably, the image capture device is secured to the trunk of the user.

According to one embodiment, the field of view is moved by an amount corresponding to rotation of the head relative to the body.

According to a second embodiment, the field of view is moved by an amount greater than rotation of the head relative to the body.

Preferably, the field of view is moved by an amount corresponding to lateral rotation of the head relative to the body.

The above and still further objects, features and advantages of the present invention will become apparent upon consideration of the following detailed description of specific embodiment thereof, especially when taken in conjunction with the accompanying drawings.

### BRIEF DESCRIPTION OF THE DRAWING

For a better understanding of the invention and to show how the same may be brought into effect, specific embodiments will now be described, by way of example, with reference to the accompanying drawings, in which:

FIG. 1 is a schematic front view of a user wearing a chest-mounted camera and a head mounted motion sensor; and

FIG. 2 is a schematic view from above of the arrangement shown in FIG. 1.

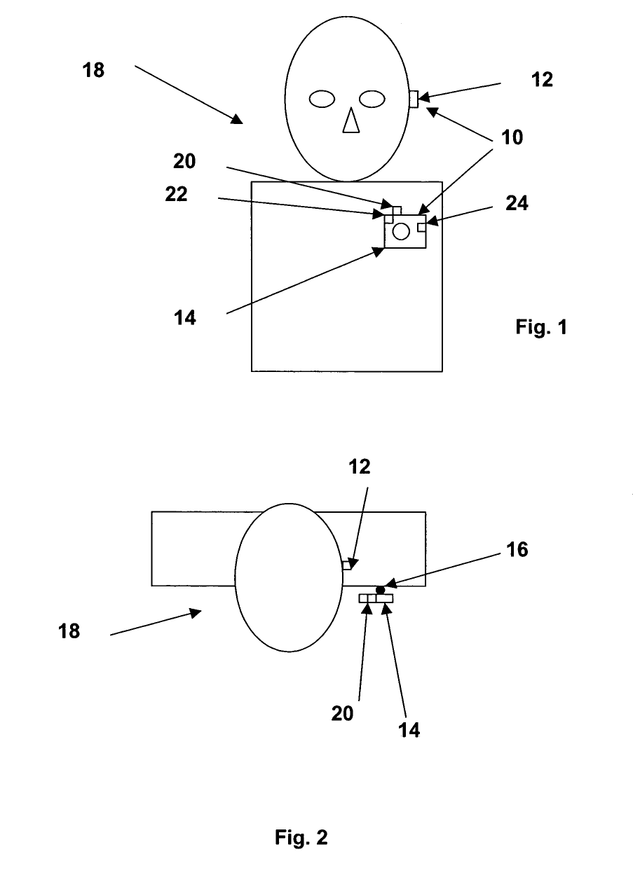

### DETAILED DESCRIPTION OF THE DRAWING

A camera apparatus 10 incorporates a head mounted motion sensor 12 and an image capture device, in the form of camera 14 mounted on a motorized pan/tilt unit 16 (see FIG. 2) secured to a user 18. The camera 14 also includes a motion sensor 20.

The head mounted motion sensor 12 and the body mounted motion sensor 20 are used to detect side to side motion of the user's head and body respectively. Such side to side motion may be a rotational motion. The motion sensors 12 and 20 can also optionally be used to detect up and down motion of the user's head and body respectively.

The motion sensors 12 and 20 can be in the form of any suitable mechanical motion sensors, e.g. micro-compasses which give an absolute measure of the direction in which the respective motion sensors 12 and 20 are pointing. Suitable calibration to a forward direction (for example with respect to a casing of the motion sensor 12/20) can be used to provide an angle of deviation from forward to indicate how a user's head or body has moved. A suitable type of compass is a Hall effect type. A specific example of such a compass is a Honeywell HMR 3200 model which has an accuracy of approximately half a degree.

An alternative type of motion sensor 12, 20 is a gyroscope, such as the Murata ENC 03J. This is a piezoelectric type device including a vibrating column which goes off axis in response to the device being moved to create a detection current.

The output of each of motion sensors 12, 20 is a signal having a value commensurate with an angle through which the particular sensor has moved. A practical example is of a user turning to one side to move his head through 45° and move his body through 25°, both with respect to an independent axis. A combiner 22 in the form of a difference unit (which can be a control portion included in a microcomputing device) receives output signals from the body mounted motion sensor 20 and the head mounted motion sensor 12. The head mounted motion sensor 12 can communicate its output via a wireless link, such as Bluetooth link. The difference unit 22 then simply subtracts the body mounted motion sensor value from the head mounted motion sensor value to obtain a signal having a value commensurate with 20° for the movement of the user's head relative to his body. This value indicates the angle through which the camera 14 should turn in order to follow movement of the user's head. Thus, the difference unit 22 sends a signal to the pan/tilt unit 16 to turn camera 14 by 20°, the amount of the calculated difference from the difference unit 22.

In this way, camera 14 is advantageously worn on a user's body, but at the same time motion of his head with respect to his body is detected and accounted for in the motion of the camera 14, which follows the direction that his head is facing.

Upward and downward motion of the user's head can also be detected, preferably with a differently orientated motion sensor to detect up/down movement of the head rather than side to side movement. In such an arrangement, the pan/tilt unit 16 moves camera 14 up/down as required, in a way similar to that as described above. Furthermore, a third degree of rotational freedom can be accounted by using an additional motion detector that detects tilting of a user's head to one side. A combination of pan and tilt can be used to compensate for such motion.

An additional feature of the camera apparatus 10 is a self-calibrator incorporated in the control portion of combiner 22. The self-calibrator performs self-calibration of the head mounted motion sensor 12 and the motion sensor 20 on the basis that, for the majority of time the camera 14 is operating, the user's head is pointing in the same direction as his body. Thus, the mean output of the difference signal from combiner 22 is adjusted to be 0°, i.e. straight ahead. Thus, calibration is achieved by taking an average over time of the difference signal that combiner 22 derives.

The body mounted motion detector 20 can also incorporate a tilt detector in anticipation of the camera drooping forward on its mounting. A signal from the tilt detector indicative of the up and down movement of the user's body is fed to the pan/tilt unit 16 to ensure that the camera 14 points forward on a horizontal axis, except of course when head motion dictates that the camera is tilted up/down.

A further optional function of the camera apparatus 10 is to combine the results of the approximate direction that the user's head faces (based on signals from the head mounted motion sensor 12 and the body mounted motion sensor 20) with aspects of stabilisation and attentional control that are disclosed by Mayol, W W et al, Wearable Visual Robots, in IEEE International Symposium on Wearable Computing, ISWC'00 Atlanta, October 2000. The stabilisation and attentional control described in Wearable Visual Robots allows the camera apparatus 10 to provide its own stabilisation of areas or objects of interest, whilst still being controlled by motion of the user's head. The Mayol disclosure has its aim of “decoupling of camera movement from the wearer's posture and motions”, whereas the intention of present embodiments is to achieve the opposite. Nevertheless, the stabilisation and attentional control disclosed by Mayol is an optional addition of the functions of the camera apparatus 10 disclosed herein.

The camera apparatus 10 preferably includes distance sensor 24 to determine the distance from the user of camera 14 to a subject having an image being captured by the camera. If the distance is known, together with an estimated or pre-calibrated distance between the camera 14 and the user's eyes, the camera direction of view is adjusted by activating pan/tilt unit 16 to remove potential parallax errors. Parallax errors are reduced when the user 18 wears the camera 14 centrally, thus isolating a parallax error to up/down tilt direction.

A co-pending, commonly-assigned application of Cheatle et al., entitled “Image Capture Systems using Motion Detection”, LHGB Docket No. 1509-456, filed on the same day as this application, incorporated herein by reference, discloses an image capture system that can also be advantageously used in the system described herein. When motion of the user's head relative to his body is detected pan/tilt unit 16 can move camera 14 by the detected amount or by an additional amount to account for movement of the eyes of the user with respect to his head.

The camera apparatus 10 described herein advantageously allows camera 14 to be worn on a user's body, but at the same time the camera is caused to follow motion of the user's head to approximate the direction the head of the user is facing. Thus, a user is freed from the necessity of wearing a camera on his head, because motion of his head is detected by a very small, unobtrusive motion sensor 12, signals from which can be transmitted wirelessly to the camera 14 which can be conveniently located, for example, on the chest or shoulder of the user.

While there have been described and illustrated a specific embodiment of the invention, it will be clear that variations in the details of the embodiment specifically illustrated and described may be made without departing from the true spirit and scope of the invention as defined in the appended claims.

1. An image capture system comprising a body-mountable image capture device, a detector arrangement for detecting the relative motion of the head and body of a person on whom the image capture device is adapted to be mounted, and a combiner adapted to be coupled with the image capture device and the detector arrangement for moving a field of view adapted to be captured by the image capture device according to the detected relative motion of the head and body of the person.

2. An image capture system as claimed in claim 1, wherein the detector arrangement includes separate motion detectors for the head and body of the person.

3. An image capture system as claimed in claim 2 wherein the motion detectors are adapted to be mounted on the person.

4. An image capture system as claimed in claim 1 wherein the body mountable image capture device is a camera adapted to be secured to the body of the user.

5. An image capture system as claimed in claim 1 further including a computing device including the combiner.

6. An image capture system as claimed in claim 1 wherein the combiner includes an image capture device adjustment section and is operable to control the adjustment section to move a field of view of the image capture device.

7. An image capture system as claimed in claim 6, wherein the combiner is adapted to respond to the detector arrangement and to derive an indication rotation of the head of the user relative to the body of the user, and the image capture device adjustment section is operable to move the field of view of the image capture device by an amount corresponding to the indication of head rotation relative to the body of the user.

8. An image capture system as claimed in claim 6, wherein the combiner is adapted to respond to the detectors and to derive an indication of rotation of the head of the user relative to the body of the user, and the image capture device adjustment section is operable to move the field of view of the image capture device by an amount greater than the measured relative head motion.

9. An image capture system as claimed in claim 2 wherein the head motion detector is operable to be secured to the head of the user.

10. An image capture system as claimed in claim 9 wherein the head motion detector is operable to detect lateral rotation of the head of the user.

11. An image capture system as claimed in claim 2 wherein the body motion detector is included in, or is a part of, the image capture device.

12. An image capture system as claimed in claim 1, further including a distance sensor operable, in conjunction with a known distance between the eyes of the user and the image capture device, to compensate for parallax errors associated with the eyes of the user.

13. An image capture system as claimed in claim 1, further including a calibrator operable to calibrate a forward direction for the motion detector arrangement in response to an indication of an average output of the motion detector arrangement adjusted so there is substantially no offset between facing directions of the body and head of the user.

14. An image capture system as claimed in claim 1 wherein the image capture device includes a tilt detector operable to adjust an image of the image capture device to account for a titling away from the horizontal of the image capture device.

15. A method of controlling an image capture device secured to the body of a user comprises:
detecting motion of the head of a user with respect to motion of the body of a user; and
moving a field of view of the image capture device according to the detected motion of the head of the user with respect to the detected motion of the body of the user.

16. A method as claimed in claim 15 wherein the image capture device is secured to the trunk of the user.

17. A method as claimed in claim 15 wherein the field of view is moved by an amount corresponding to rotation of the head relative to the body.

18. A method as claimed in claim 15 wherein the field of view is moved by an amount greater than rotation of the head relative to the body.

19. A method as claimed in claim 15 wherein the field of view is moved by an amount corresponding to lateral rotation of the head relative to the body.
